(19) United States
(12) Patent Application Publication
(10) Pub. No.: US 2026/0238413 A1
(43) Pub. Date: Aug. 13, 2026

(54) METHOD, USER EQUIPMENT, AND COMMUNICATION SYSTEM FOR BEAM INDICATION FOR LTM

(71) Applicant: SHARP KABUSHIKI KAISHA, Sakai City, Osaka (JP)

(72) Inventors: CHIA-HUNG LIN, Taipei (TW); MEI-JU SHIH, Taipei (TW); WAN-CHEN LIN, Taipei (TW)

(21) Appl. No.: 19/156,606

(22) PCT Filed: Feb. 6, 2024
(86) PCT No.: PCT/CN2024/076242

§ 371 Date: Aug. 14, 2025

Related U.S. Application Data
(60) Provisional application No. 63/446,607, filed on Feb. 17, 2023.

(51) Int. Cl. H04L 5/00; H04B 7/06

(52) U.S. Cl. CPC H04L 5/0044; H04B 7/06952

(57) ABSTRACT

A method for beam indication for LTM performed by a UE is provided. The method includes receiving, from a source cell, at least one candidate cell configuration, each of the at least one candidate cell configuration including at least one TCI state list; receiving, from the source cell, a cell switching MAC CE indicating a target cell and activating and indicating at least one TCI state associated with the indicated target cell, the activated and indicated at least one TCI state being included in the at least one TCI state list included in one of the at least one candidate cell configuration, and the one of the at least one candidate cell configuration corresponding to the indicated target cell; and performing, based on the activated and indicated at least one TCI state, UL transmissions to the indicated target cell and DL receptions from the indicated target cell.

### CROSS-REFERENCE TO RELATED APPLICATION(S)

The present disclosure claims the benefit of and priority to U.S. Provisional Patent Application Ser. No. 63/446,607, filed on Feb. 17, 2023, entitled “ENHANCEMENT ON BEAM INDICATION FOR LTM” (“the '607 provisional”). The contents of the '607 provisional are hereby incorporated herein fully by reference into the present disclosure for all purposes.

### FIELD

The present disclosure is related to wireless communication and, more specifically, to a method, a user equipment (UE), and a communication system for beam indication for layer 1 (L1)/layer 2 (L2)-triggered mobility (LTM) in cellular wireless communication networks.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a method, a user equipment (UE), and a communication system for beam indication for layer 1 (L1)/layer 2 (L2)-triggered mobility (LTM) in cellular wireless communication networks.

In a first aspect of the present application, a method for beam indication for LTM performed by a UE is provided. The method includes receiving, from a source cell, at least one candidate cell configuration, each of the at least one candidate cell configuration including at least one transmission configuration indication (TCI) state list; receiving, from the source cell, a cell switching MAC CE indicating a target cell and activating and indicating at least one TCI state associated with the indicated target cell, the activated and indicated at least one TCI state being included in the at least one TCI state list included in one of the at least one candidate cell configuration, and the one of the at least one candidate cell configuration corresponding to the indicated target cell; and performing, based on the activated and indicated at least one TCI state, uplink (UL) transmissions to the indicated target cell and downlink (DL) receptions from the indicated target cell.

In an implementation of the first aspect, the method further includes receiving, from the source cell, a radio resource control (RRC) parameter indicating a joint mode or a separate mode. In a case that the RRC parameter indicates the joint mode, the activated and indicated at least one TCI state is a joint TCI state included in a joint TCI state list of the at least one TCI state list, and the UL transmissions to the indicated target cell and the DL receptions from the indicated target cell are performed based on the joint TCI state, and in a case that the RRC parameter indicates the separate mode, the activated and indicated at least one TCI state is a DL TCI state included in a DL TCI state list of the at least one TCI state list and an UL TCI state included in an UL TCI state list of the at least one TCI state list, the UL transmissions to the indicated target cell are performed based on the UL TCI state, and the DL receptions from the indicated target cell are performed based on the DL TCI state.

In another implementation of the first aspect, the activated and indicated at least one TCI state is associated with a synchronization signal block (SSB) associated with the indicated target cell, and the SSB is configured to perform layer 1 (L1) beam measurement for the indicated target cell.

In another implementation of the first aspect, the activated and indicated at least one TCI state is applied to the UL transmissions to the indicated target cell and the DL receptions from the indicated target cell after a timing gap.

In another implementation of the first aspect, the timing gap is predefined or configured by the source cell.

In a second aspect of the present application, a UE for beam indication for LTM is provided. The UE includes one or more processors; and at least one memory coupled to the one or more processors, the at least one memory storing computer-executable instructions that, when executed by the one or more processors, cause the UE to receive, from a source cell, at least one candidate cell configuration, each of the at least one candidate cell configuration including at least one transmission configuration indication (TCI) state list; receive, from the source, a cell switching MAC CE indicating a target cell and activating and indicating at least one TCI state associated with the indicated target cell, the activated and indicated at least one TCI state being included in the at least one TCI state list included in one of the at least one candidate cell configuration, and the one of the at least one candidate cell configuration corresponding to the indicated target cell; and perform, based on the activated and indicated at least one TCI state, uplink (UL) transmissions to the indicated target cell and downlink (DL) receptions from the indicated target cell.

In a third aspect of the present application, a communication system for beam indication for LTM is provided. The communication system includes a user equipment (UE); a source cell; and a target cell. The source cell is configured to transmit, to the UE, at least one candidate cell configuration, each of the at least one candidate cell configuration includes at least one transmission configuration indication (TCI) state list, the source cell is further configured to transmit, to the UE, a cell switching MAC CE indicating the target cell and activating and indicating at least one TCI state associated with the target cell, the activated and indicated at least one TCI state is included in the at least one TCI state list included in one of the at least one candidate cell configuration, and the one of the at least one candidate cell configuration corresponds to the target cell, and the UE is configured to perform, based on the activated and indicated at least one TCI state, uplink (UL) transmissions to the target cell and downlink (DL) receptions from the target cell

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method for beam indication for LTM performed by a UE, according to an example implementation of the present disclosure.

FIG. 2 is a flowchart illustrating a method for beam indication for LTM performed by a communication system, according to an example implementation of the present disclosure.

FIG. 3 is a block diagram illustrating a node for wireless communication, according to an example implementation of the present disclosure.

### DESCRIPTION

Some abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| BWP | Bandwidth Part |
| CA | Carrier Aggregation |
| CB | CodeBook |
| CBRA | Contention-Based Random Access |
| CFRA | Contention-Free Random Access |
| CORESET | Control Resource Set |
| CC | Component Carrier |
| CCE | Control Chanel Element |
| CE | Control Element |
| CHO | Conditional Hand Over |
| CPE | Customer Premises Equipment |
| CRC | Cyclic Redundancy Check |
| C-RNTI | Cell-Radio Network Temporary Identifier |
| CS-RNTI | Configured Scheduling-Radio Network |
| | Temporary Identifier |
| CSS | Common Search Space |
| CSI | Channel State Information |
| DAPS | Dual Active Protocol Stack |
| DC | Dual Connectivity |
| DCI | Downlink Control Information |
| DL | Downlink |
| FWA | Fixed Wireless Access |
| GC-PDCCH | Group Common-Physical Downlink Control Channel |
| HARQ | Hybrid Automatic Repeat Request |
| HO | Hand Over |
| IE | Information Element |
| IIoT | Industrial Internet of Things |
| LSB | Least Significant Bit |
| LTE | Long Term Evolution |
| LTM | Layer 1/Layer 2-Triggered Mobility |
| L1 | Layer 1 |
| L2 | Layer 2 |
| L3 | Layer 3 |
| MAC | Medium Access Control |
| MCG | Master Cell Group |
| MCS | Modulation Coding Scheme |
| MCS-C-RNTI | Modulation Coding Scheme-Cell-Radio Network |
| | Temporary Identifier |
| MIMO | Multiple-input Multiple-output |
| MSB | Most Significant Bit |
| multi-TRP | multiple Transmission and Reception Point |
| NACK | Negative Acknowledgment |
| NDI | New Data Indicator |
| non-CB | non-CodeBook |
| NR | New RAT/Radio |
| NW | Network |
| PCell | Primary Cell |
| PCI | Physical Cell ID |
| PSCell | Primary Secondary Cell |
| PBCH | Physical Broadcast Channel |
| PDCCH | Physical Downlink Control Channel |
| PDSCH | Physical Downlink Shared Channel |
| PDU | Protocol Data Unit |
| P-MPR | Power management Maximum Power Reduction |
| PH | Power Headroom |
| PHR | Power Headroom Report |
| PHY | Physical (layer) |
| PRACH | Physical Random Access Channel |
| PTAG | Primary Timing Advance Group |
| PTRS | Phase Tracking Reference Signal |
| PUCCH | Physical Uplink Control Channel |
| PUSCH | Physical Uplink Shared Channel |
| RA | Random Access |
| RACH | Random Access Channel |
| RAN | Radio Access Network |
| RAR | Random Access Response |
| Rel | Release |
| RMSI | Remaining Minimum System Information |
| RNTI | Radio Network Temporary Identifier |
| RRC | Radio Resource Control |
| RSRP | Reference Signal Received Power |
| RSRQ | Reference Signal Received Quality |
| RSSI | Reference Signal Strength Indication |
| RV | Redundancy Version |
| SCell | Secondary Cell |
| SCG | Secondary Cell Group |
| SCS | Subcarrier Spacing |
| SDM | Spatial Domain Multiplexing |
| SFN | Single-Frequency Network |
| SINR | Signal to Interference plus Noise Ratio |
| SpCell | Special Cell |
| SR | Scheduling Request |
| SRS | Sounding Reference Signal |
| SRI | SRS resource indicator |
| SSB | Synchronization Signal Block |
| STAG | Secondary Timing Advance Group |
| STxMP | Simultaneous Transmission on Multiple Panels |
| TA | Timing Advance |
| TAG | Timing Advance Group |
| TB | Transport Block |
| TBS | Transport Block |
| TCI | Transmission Configuration Indication |
| TDM | Time Division Multiplexing |
| TPC | Transmission Power Control |
| TPMI | Transmission Precoding Matrix Indicator |
| TR | Technical Report |
| TRI | Transmit Rank Indication |
| TS | Technical Specification |
| QCL | Quasi-CoLocation |
| UE | User Equipment |
| UL | Uplink |
| URLLC | Ultra Reliable Low Latency Communication |
| USS | UE-Specific Search Space |
| WCDMA | Wideband Code Division Multiple Access |
| WG | Working Group |
| WI | Working Item |
| ZP-CSI-RS | Zero power CSI-RS |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, at least one of A and B.

Examples of some selected terms in the present disclosure are provided as follows.
Antenna Panel: A conceptual term for UE antenna implementation. It may be assumed that a panel is an operational unit for controlling a transmit spatial filter (beam). A panel may typically consist of a plurality of antenna elements. In some implementations, a beam may be formed by a panel. To form two beams simultaneously, two panels may be needed. Such simultaneous beamforming from multiple panels may be subject to UE capability. A similar definition for “panel” may be possible by applying spatial receiving filtering characteristics.
Beam: The term “beam” may be interpreted as a spatial filter. For example, when UE reports a preferred gNB transmit (TX) beam, the UE is essentially selecting a spatial filter used by the gNB. The term “beam information” may be used to provide information about which beam/spatial filter is being used/selected. In some implementations, individual reference signals may be transmitted by applying individual beams (spatial filters). Therefore, the term “beam” or “beam information” may be represented by one or more reference signal resource indices.
DCI: There may be various DCI formats used in PDCCH in LTE. The DCI format may be a predefined format in which the downlink control information is packed/formed and transmitted in PDCCH.
TCI state: A TCI state may include parameters for configuring a QCL relationship between one or two DL reference signals and a target reference signal set. For example, a target reference signal set may include the Demodulation Reference Signals (DM-RS) ports of PDSCH or PDCCH.
HARQ: A functionality that ensures delivery between peer entities at Layer 1 (e.g., the Physical Layer). A single HARQ process may support one Transport Block (TB) when the physical layer is not configured for downlink/uplink spatial multiplexing. When the physical layer is configured for downlink/uplink spatial multiplexing, a single HARQ process may support one or multiple TBs. There may be one HARQ entity per serving cell, and each of HARQ entity may support a number of parallel DL and UL HARQ processes.

In 3GPP RAN #97-e meeting, LTM was approved as a work item in Rel-18 of NR. The details for study may be as follows:

To specify mechanism and procedures of L1/L2-based inter-cell mobility to reduce mobility latency, including:
(a) Configuration and maintenance of multiple candidate cells to allow rapid application of configurations for the multiple candidate cells,
(b) A dynamic switch mechanism among candidate serving cells (e.g., including SpCell and SCell) for potential applicable scenarios based on L1/L2 signaling,
(c) L1 enhancements for inter-cell beam management, including L1 measurement and reporting, and beam indication,
(d) Timing Advance management, and
(e) CU-DU interface signaling to support L1/L2 mobility, if needed.

Different from the legacy HO (e.g., L3 HO, CHO, and DAPS), LTM may perform HO via L1/L2 signaling. This may mean that the LTM procedure may effectively reduce latency of HO. However, before, during or after a UE is switched from the source cell to a selected candidate target cell, the UE may be required to be indicated a beam to receive DL signal(s) from the selected candidate target cell, and/or transmit UL signal(s) to the selected candidate target cell. Therefore, the present disclosure may aim to design a beam indication method corresponding to the LTM procedure for HO. It may be noted that the selected candidate target cell may be a candidate target cell that the gNB has indicated to the UE for cell switching.

The “an antenna port” and “antenna ports” mentioned in the present disclosure may be referred to as “an antenna port used for transmission of one or more PUSCHs/PUCCHs” and “antenna ports used for transmission of one or more PUSCHs/PUCCHs.”

A QCLed with B may mean that the A shares the same channel characteristic/QCL assumption with B. Type of the channel characteristic/QCL assumption may be the following types:
‘typeA’: {Doppler shift, Doppler spread, average delay, delay spread},
‘typeB’: {Doppler shift, Doppler spread},
‘typeC’: {Doppler shift, Doppler spread}, and
‘typeD’: {Spatial Rx parameter}.

The source cell/gNB may configure one or more candidate target cells to a UE for performing LTM procedure. Each candidate target cell may be identified by a PCI value. For example, if a UE is configured with seven candidate target cells by the source cell/gNB, these candidate target cells may be identified by the values PCI #1, PCI #2, . . . , and PCI #7.

L1/L2 mobility may be an efficient way to reduce the latency of HO since the decision and measurement may be performed in L2 and/or L1 (e.g., of the UE and/or of the gNB). During the LTM procedure, at least one of the following actions (a)-(e) may be performed to perform LTM-based HO.
(a) RRC pre-configuration: The UE may be configured with the information/one or more configurations associated with the candidate target cells from the source cell/gNB via RRC signaling. The information/one or more configurations may include a configuration corresponding to the beam/cell measurement (e.g., one or more RSs/SSBs used for the beam/cell measurement, one or more TCI states used for receiving the one or more RSs used for the beam/cell measurement), a configuration corresponding to the DL synchronization (e.g., one or more SSBs configurations corresponding to each of the candidate target cells), and a configuration corresponding to the UL synchronization (e.g., an RACH configuration corresponding to each of the candidate target cells, an indicator indicating whether a candidate target cell to perform an RA procedure).

In some implementations, a UE may be configured with one or more RRC (pre-)configurations by the source cell/gNB, and each of the one or more RRC (pre-)configurations may include the information/one or more configurations associated with a candidate target cell.

In some implementations, a UE may be configured with one or more group RRC (pre-)configurations by the source cell/gNB, and each of the one or more group RRC (pre-)configurations may include the information/one or more configurations corresponding to a group of candidate target cells. The group of candidate target cells may be multiple candidate target cells with the same properties. The properties may include a geographic location, a BWP, a cell/gNB capability (e.g., only support 3GPP Rel-15 TCI framework), etc. For example, a UE may be configured with multiple group pre-configurations by the source cell/gNB. Each of the multiple group pre-configurations may include the information/one or more configurations corresponding to a group of candidate target cells, and each of the group of candidate target cells may be associated with a group ID.

In some implementations, a UE may be configured with a common RRC (pre-)configuration by the source cell/gNB, and the common RRC (pre-)configuration may include the information/one or more configurations corresponding to all candidate target cells. The information/one or more configurations corresponding to all candidate target cells may include a threshold value (e.g., an RSRP, an RSSI, an RSRQ) configured to the UE for determining whether the L1 beam/cell measurement result of a candidate target cell is good or not, a list of SSB configurations corresponding to different candidate target cells, and/or a list of RS (e.g., CSI-RS or PTRS) configurations used to perform the L1 beam/cell measurement to different candidate target cells.
(b) Measurement and Report: The UE may measure the L1 beam/cell qualities corresponding to each candidate target cell.

In some implementations, a UE may be configured with one or more reference signals (e.g., one or more SSBs, one or more CSI-RSs, one or more PTRSs) by the source cell/gNB for performing L1 beam/cell quality measurement to each candidate target cell during the LTM procedure. The configuration of the one or more reference signals may be included in an RRC (pre-)configuration of each candidate target cell, a group RRC (pre-)configuration, and/or a common RRC (pre-)configuration transmitted by the source cell/gNB. If the UE is configured with more than one RSs for performing the L1 beam/cell quality measurement to a candidate target cell, at least one of the RSs may be an SSB. And other RSs (e.g., non-SSB RS(s)) may be associated with the SSB associated with the PCI different from the PCI of the serving cell/source cell.

In some implementations, a UE may be configured with one or more CSI-RSs for performing the L1 beam/cell quality measurement to a candidate target cell. Each of the one or more CSI-RSs may be associated with an SSB corresponding to the candidate target cell. In addition, there may be a higher layer parameter to indicate whether the associated SSB and the CSI-RS are QCLed with respect to ‘typeD’.

In some implementations, a UE may be configured with a list of SSBs in a common RRC (pre-)configuration for performing the L1 beam/cell quality measurement to one or more candidate target cells configured to the UE. Each SSB in the list of SSBs may correspond to the one or more candidate target cells.

In some implementations, a UE may be configured with a list of SSBs in a common RRC (pre-)configuration. Each SSB in the list of SSBs may correspond to a different candidate target cell (e.g., each SSB in the list of SSBs may be associated with a specific PCI value). The UE may be configured with one or more CSI-RSs for performing the L1 beam/cell quality measurement to a candidate target cell. The one or more CSI-RSs may be associated with one or more SSBs in the list of SSBs included in the common RRC (pre-)configuration. The associated PCI value of the one or more SSBs may be the same as the PCI value of the candidate target cell.

After the UE performs the L1 beam/cell quality measurement, the UE may transmit the beam/cell quality report to the source cell/gNB in the one or more configured physical resources. The one or more configured physical resources may be configured by the source cell/gNB in the RRC (pre-)configuration corresponding to a candidate target cell or in the common RRC (pre-)configuration. In addition, the one or more configured physical resources may be time/frequency resources, a BWP, a configured grant, a PUSCH, and/or a PUCCH.
(c) DL Synchronization: A UE may perform the DL synchronization based on the SSB corresponding to at least one candidate target cell. The information/configuration of the SSB corresponding to each candidate target cell may be configured by the source cell/gNB in the action (a) (RRC (pre-)configuration) corresponding to a candidate target cell or in the common RRC (pre-)configuration.

The action (c) (DL synchronization) may be performed by the UE before or after the action (e) (cell switch command). In a case that the action (c) (DL synchronization) is performed by the UE before the action (e) (cell switch command), the UE may perform the DL synchronization to at least one of the candidate target cells. In some implementations, the UE may perform the DL synchronization to each candidate target cell, respectively. In some implementations, the UE may perform the DL synchronization to the candidate target cells that have good channel quality. It may be noted that good channel quality may mean that the measured beam/cell quality is greater than a threshold value (e.g., an RSRP or an RSSI value configured by the source cell/gNB via RRC signaling in the RRC (pre-)configuration corresponding to a candidate target cell or common RRC (pre-)configuration). In a case that the action (c) (DL synchronization) is performed by the UE after the action (e) (cell switch command), the UE may perform the DL synchronization to the selected candidate target cell. In some implementations, the UE may perform the DL synchronization to the candidate target cell indicated in the cell switch MAC CE. It may be noted that the number of candidate target cells indicated in the cell switch MAC CE may be more than one.
(d) UL Synchronization: A UE may perform an RA procedure for the UL synchronization to at least one candidate target cell. In some implementations, the UE may not perform the RA procedure for the UL synchronization to the at least one candidate target cell.

If the action (d) (UL synchronization) is performed by the UE before the action (e) (cell switch command), the UE may perform the UL synchronization to at least one of the candidate target cells. In some implementations, the UE may perform the UL synchronization to each candidate target cell, respectively.

In some implementations, the UE may perform the UL synchronization to the candidate target cells that have good channel quality. It may be noted that good channel quality may mean that the measured beam/cell quality is greater than a threshold value (e.g., an RSRP or an RSSI value configured by the source cell/gNB via RRC signaling in the RRC (pre-)configuration corresponding to a candidate target cell or common RRC (pre-)configuration).

In some implementations, a UE may determine whether to perform the UL synchronization to a candidate target cell based on the L1 beam/cell measurement result of the candidate target cell. For example, a UE may be configured with a threshold (e.g., an RSRP, an RSRQ or an RSSI) by the source cell/gNB, and the threshold may be an RRC parameter included in the common RRC (pre-)configuration or the RRC (pre-)configuration corresponding to the candidate target cell. If the L1 beam/cell measurement result of a candidate target cell is greater than the threshold, the UE may decide to perform the UL synchronization to the candidate target cell. It may be noted that the UL synchronization may be achieved by one or more RACH-based schemes (e.g., a PDCCH-ordered RACH) and/or one or more RACH-less schemes (e.g., a UE-based TA measurement). If the UE applies the one or more RACH-less schemes to achieve the UL synchronization, the UE may transmit the TA report corresponding to one or more candidate target cells to the source cell/gNB on one or more configured physical resources. The one or more configured physical resources may be request by the UE from the source cell/gNB, or may be pre-configured in the common RRC (pre-)configuration or the RRC (pre-)configuration corresponding to the candidate target cell by the source cell/gNB.

If the action (d) (UL synchronization) is performed by the UE after the action (e) (cell switch command), the UE may perform the UL synchronization to the selected candidate target cell. In some implementations, the UE may perform the UL synchronization to the candidate target cell indicated in the cell switch MAC CE. It may be noted that the number of candidate target cells indicated in the cell switch MAC CE may be more than one.

If the UE achieves the UL synchronization via the RA procedure, the RACH configuration/information (e.g., a RACH occasion, a preamble index) corresponding to each candidate target cell may be provided in the RRC (pre-)configuration corresponding to the candidate target cell or common RRC (pre-)configuration by the source cell/gNB.
(e) Cell switch command: A UE may receive a MAC CE including the information/configuration corresponding to the selected candidate target cell. The MAC CE may be transmitted by the source cell/gNB.

In some implementations, a UE may perform a PDCCH-ordered RACH to achieve the UL synchronization before the action (e) (cell switch command). The UE may receive DCI transmitted by the source cell/gNB in a search space, and the DCI may be used to indicate to perform the RA to the selected candidate target cell. The DCI may include a field used to indicate the selected candidate target cell to the UE. In addition, the search space may be a common search space, a UE-specific search space, and/or an LTM-specific search space configured by the source cell/gNB. After the UE transmits the preamble to the selected candidate target cell, the UE may receive DCI used to schedule a PDSCH during the timing window, and the cell switch MAC CE may be transmitted on the PDSCH. The timing window may be pre-defined or configured by the source cell/gNB in the common RRC (pre-)configuration or the RRC (pre-)configuration corresponding to the selected candidate target cell. If the UE does not receive the DCI used to schedule the PDSCH carrying the cell switch MAC CE during the timing window, the UE may retransmit the preamble to the source cell/gNB.

In some implementations, a UE may perform a RACH-less scheme to achieve the UL synchronization before the action (e) (cell switch command). After performing the RACH-less scheme to achieve the UL synchronization, the UE may transmit the TA report corresponding to one or more candidate target cells to the source cell/gNB on the one or more configured physical resources. Afterwards, the UE may receive DCI used to schedule a PDSCH during the timing window, and the cell switch MAC CE may be transmitted on the PDSCH. The timing window may be pre-defined or configured by the source cell/gNB in the common RRC (pre-)configuration or the RRC (pre-)configuration corresponding to the selected candidate target cell. If the UE does not receive the DCI used to schedule the PDSCH carrying the cell switch MAC CE during the timing window, the UE may retransmit the TA report to the source cell/gNB.

In some implementations, a UE may perform a RACH-less scheme to achieve the UL synchronization before the action (e) (cell switch command). After performing the RACH-less scheme to achieve the UL synchronization, the UE may transmit the TA report corresponding to one or more candidate target cells to the source cell/gNB on the one or more configured physical resources. Afterwards, the UE may start a timer for receiving DCI used to schedule a PDSCH, and the cell switch MAC CE may be transmitted on the PDSCH. The timer may be pre-defined or configured by the source cell/gNB in the common RRC (pre-)configuration or the RRC (pre-)configuration corresponding to the selected candidate target cell, and the UE may stop the timer when receiving the DCI used to schedule the PDSCH carrying the cell switch MAC CE. If the timer expires, the UE may retransmit the TA report to the source cell/gNB.

### Beam Indication for LTM

During the LTM procedure, a UE may be indicated the beam information/configuration corresponding to one or more selected candidate target cells via RRC signaling, a MAC CE, and/or DCI. In addition, the beam information/configuration corresponding to the one or more selected candidate target cells may be indicated by the source gNB/cell and/or the selected candidate target cell. And the beam information/configuration corresponding to the one or more selected candidate target cells may be indicated to the UE before, during, and/or after the action (e) (cell switch command).

In order to indicate the beam information/configuration corresponding to the selected candidate target cell to a UE, the source cell/gNB may configure one or more lists of beam information/configuration (e.g., TCI states) corresponding to the candidate target cells in the common RRC (pre-)configuration and/or the RRC (pre-)configuration corresponding to a candidate target cell. The TCI states may include an UL TCI state, a DL TCI state, and/or joint TCI state. The UL TCI state may be used to indicate the transmit beam for UL transmission to the UE, the DL TCI state may be used to indicate the receive beam for DL reception to the UE, and the joint TCI state may be used to indicate the common beam for both UL transmission and DL reception to the UE.

In some implementations, the type of the TCI states may be indicated by the source cell/gNB via an RRC parameter included in the RRC pre-configuration. In some implementations, a UE may be configured with one or more RRC (pre-)configurations by the source cell/gNB, and each of the one or more RRC (pre-)configurations may be associated with a specific candidate target cell (e.g., each of the one or more RRC (pre-)configurations may include an RRC parameter to indicate the cell ID (e.g., a PCI index, a serving cell ID, and/or an additionalPCI index)). The RRC (pre-)configuration may include a RRC parameter used to indicate the type of the TCI states. The type of the TCI states may include a separate mode (e.g., the TCI states may include DL TCI states or UL TCI states) or a joint mode (e.g., the TCI states may include joint TCI states).

In some implementations, an RRC (pre-)configuration associated with a candidate target cell may include an RRC parameter used to indicate the type of the TCI states. If the RRC parameter indicates a separate mode, the RRC (pre-)configuration associated with the candidate target cell may include two lists of TCI states (e.g., a list of DL TCI states and a list of UL TCI states). A UE may be configured with one or more RRC (pre-)configurations associated with different candidate target cells by the source cell/gNB.

In some implementations, an RRC (pre-)configuration associated with a candidate target cell may include an RRC parameter used to indicate the type of the TCI states. If the RRC parameter indicates a joint mode, the RRC (pre-)configuration associated with the candidate target cell may include a list of TCI states (e.g., a list of joint TCI states). A UE may be configured with one or more RRC (pre-)configurations associated with different candidate target cells by the source cell/gNB.

In some implementations, a UE may be configured with one or more common RRC (pre-)configurations by the source cell/gNB, and the one or more common RRC (pre-)configurations may be associated with all candidate target cells and/or dedicated for the LTM procedure. At least one of the one or more common RRC (pre-)configurations may include an RRC parameter used to indicate the type of the TCI states. The type of the TCI states may include a separate mode (e.g., the TCI states may include DL TCI states or UL TCI states) or a joint mode (e.g., the TCI states may include joint TCI states).

In some implementations, a common RRC (pre-)configuration associated with all candidate target cells may include an RRC parameter used to indicate the type of the TCI states. If the RRC parameter indicates a separate mode, the common RRC (pre-)configuration may include two lists of TCI states (e.g., a list of DL TCI states and a list of UL TCI states). A UE may be configured with one or more common RRC (pre-)configurations associated with all candidate target cells and/or dedicated for the LTM procedure by the source cell/gNB. Each DL TCI state included in the list of DL TCI states and/or each UL TCI state included in the list of UL TCI states may be associated with a cell ID, and the cell ID may include a serving cell ID, a PCI, and/or an additionalPCI index. Each additionalPCI index, serving cell ID, or/and PCI index may be associated with an SSB configuration corresponding to a candidate target cell.

In some implementations, each candidate cell may associate with a TCI configuration. For example, each TCI configuration may include a PCI index, a cell index, an additionalPCI index to associate a DL TCI state or an UL TCI state with a candidate cell when a separate mode is configured/indicated. In some implementations, each candidate cell may associate with a TCI configuration. For example, each TCI configuration may include a PCI index, a cell index, an additionalPCI index to associate a joint TCI state with a candidate cell when a joint mode is configured/indicated. In some implementations, each candidate cell may associate with a TCI state. The source RS of the TCI state may be an SSB associated with the candidate target cell. The CSI-RS and the SSB associated with the TCI state included in the CSI-RS configuration may be QCLed with respect to ‘typeD’.

In some implementations, a UE may be configured with one or more RRC (pre-)configurations by the source cell/gNB. Each of the one or more RRC (pre-)configurations may be associated with a candidate target cell. The RRC (pre-)configuration associated with the candidate target cell may include one or more RS configurations (e.g., a SSB configuration, a CSI-RS configuration, and/or a PTRS configuration) used for the L1 beam/cell measurement. The one or more RS configurations may be associated with a TCI state, respectively. The TCI states associated with the one or more RS configurations may be included in a list of TCI states configured to the UE by the source cell/gNB. The TCI states included in the list of TCI states may be associated with different candidate target cells or the same candidate target cell.

In some implementations, if an RRC (pre-)configuration associated with a candidate target cell includes (only) one RS configuration applied for the L1 beam/cell measurement, the source RS of the TCI state associated with the RS configuration may be the SSB associated with the candidate target cell (e.g., the SSB index may be associated with a cell ID (e.g., a PCI) and/or a TCI state may be associated with an SSB index associated with a cell index). In some implementations, if a candidate target cell is configured with one RS for the L1 measurement, the TCI state corresponding the RS may be associated with the SSB of the candidate target cell (e.g., the PCI value and/or the additionalPCI index of the candidate target cell may be included in the configuration of the TCI state).

In some implementations, an RRC (pre-)configuration associated with a candidate target cell may include a first RS configuration and a second RS configuration applied for the L1 beam/cell measurement, and the RRC (pre-)configuration may be configured to a UE by the source cell/gNB. The first RS configuration may be an SSB configuration associated with the candidate target cell. The second RS configuration may be a CSI-RS configuration. The CSI-RS and the SSB associated with the candidate target cell may be QCLed with respect to ‘typeD’.

In some implementations, a UE may be configured with multiple RRC (pre-)configurations associated with difference candidate target cells by the source cell/gNB. In addition, the UE may be configured with a list of SSB configurations, and each SSB configuration included in the list of SSB configurations may be associated with a candidate target cell. If an RRC (pre-)configuration associated with a candidate target cell (e.g., PCI=X) does not include any RS configurations for the L1 beam/cell measurement, the UE may apply the SSB configuration associated with the candidate target cell (e.g., PCI=X) for the L1 beam/cell measurement. The SSB configuration associated with the candidate target cell (e.g., PCI=X) may be included in the list of SSB configurations configured by the source cell/gNB.

For example, if the RRC (pre-)configuration associated with the candidate target cell #M (e.g., PCI=X) configured to a UE does not include any RS configurations used for the L1 beam/cell measurement, the UE may apply the SSB associated with the candidate target cell #M (e.g., PCI=X) for the L1 beam/cell measurement. In addition, if the candidate target cell #M (e.g., PCI=X) is the selected candidate target cell, the UE may not be indicated with one or more TCI states in the cell switch MAC CE for one or more DL channel/signal receptions from the selected candidate target cell and/or one or more UL channel/signal transmissions to the selected candidate target cell. Instead, the UE may assume that the DL channel(s)/signal(s) transmitted by the selected candidate target cell may be QCLed with the SSB associated with the selected candidate target cell and/or the transmit beam used to transmit UL channel(s)/signal(s) to the selected candidate target cell may be associated with the SSB associated with the selected candidate target cell. The SSB configuration associated with the selected candidate target cell may be included in the RRC (pre-)configuration associated with the selected candidate target cell, the common RRC (pre-)configuration configured for the LTM procedure, and/or a list of SSB configurations configured to a UE by the source cell/gNB.

In some implementations, if a candidate cell is not configured with any RSs in the RRC pre-configuration, the associated RSs in the TCI configuration may refer to the RSs configured in the source cell/gNB. For example, if the UE has not received the RSs configuration, the beam indication for the DL reception or the UL transmission in the target cell may be associated with the RSs configuration in the source cell/gNB as a default beam. In some implementations, a UE may be indicated with one or more beams for receiving DL signals transmitted from the selected candidate target cell via the cell switch MAC CE transmitted by the source cell/gNB. In some implementations, a UE may be indicated with one or more beams for transmitting UL signals to the selected candidate target cell via the cell switch MAC CE transmitted by the source cell/gNB.

In some implementations, the cell switch command may be transmitted by the source cell/gNB via a MAC CE. The MAC CE may include at least one of the following fields (a)-(j):
(a) Physical Cell ID: This field may indicate the identity of the candidate target cell for which the MAC CE applies.
(b) CC group: This field may indicate a set of candidate target cells.
(c) BWP ID: This field may indicate the BWP of the candidate target cell that the MAC CE applies to.
(d) TCI state ID: This field may indicate an identifier of the TCI state used for the selected candidate target cell. It may be noted that this field may indicate one of the following (i)-(viii):
(i) A DL TCI state,
(ii) An UL TCI state,
(iii) A DL TCI state and an UL TCI state,
(iv) A joint TCI state,
(v) Two DL TCI states,
(vi) Two UL TCI states,
(vii) Two DL TCI states and Two UL TCI states, and
(viii) Two joint TCI states.
(e) TAG ID: This field may indicate the TAG identity of the addressed TAG.
(f) Timing Advanced Command: This field may indicate the index value TA used to control the amount of timing adjustment that the MAC entity may apply.
(g) D/U: This field may indicate whether the TCI state ID in the same octet is for joint/downlink or uplink TCI state. If this field is set to 1, the TCI state ID in the same octet may be for joint/downlink. If this field is set to 0, the TCI state ID in the same octet may be for uplink.
(h) CORESETPoolindex: This field may indicate whether the indicated DL reception or UL transmission is associated with same TRP.
(i) Applied mTRP scheme: A codepoint may indicate ‘SDM’, ‘SFN’, and ‘CJT’ scheme, respectively.
(j) R: It may be reserved bit, set to 0.

In some implementations, when a UE receives a cell switch MAC CE indicating one or more TCI states, the UE may transmit an acknowledgment on a PUCCH to the source cell/gNB to complete the LTM procedure. Then the UE may apply the one or more TCI states indicated by the cell switch MAC CE for receiving DL channel(s)/signal(s) from the selected candidate target cell and/or transmitting UL channel(s)/signal(s) to the selected candidate target cell. The PUCCH resource may be indicated in the DCI used to schedule the PDSCH carrying the cell switch MAC CE or the cell switch MAC CE.

In some implementations, when a UE is indicated with one or more TCI states by the cell switch MAC CE transmitted by the source cell/gNB, the UE may need a timing gap to apply the one or more indicated TCI states for receiving DL channel(s)/signal(s) from the selected candidate target cell and/or transmitting UL channel(s)/signal(s) to the selected candidate target cell. The timing gap may be predefined or be configured by the source cell/gNB. If the UE needs to receive DL channel(s)/signal(s) from the selected candidate target cell and/or transmit UL channel(s)/signal(s) to the selected candidate target cell during the timing gap, the UE may apply the beam associated with the SSB associated with the selected candidate target cell for DL channel/signal receptions and/or UL channel/signal transmissions. In some implementations, during the timing gap, the UE may (1) keep the DL channel/signal receptions and UL channel/signal transmissions with the source cell via the beams/TRPs associated with the source cell, or (2) apply the beam associated with the SSB associated with the selected candidate target cell for DL channel/signal receptions and/or UL channel/signal transmissions.

In some implementations, during the timing gap, the UE may assume that the DM-RS ports of DL channel(s)/signal(s) of the (selected) candidate target cell are QCLed with the SSB with respect to a QCL assumption (e.g., ‘typeA’, ‘typeB’, ‘typeC’, and/or ‘typeD’). The configuration of the SSB may be associated with the (selected) candidate target cell (e.g., the configuration of the SSB may be associated with a cell ID, a PCI, and/or an additionalPCI index associated with the (selected) candidate target cell). The SSB associated with a cell ID, a PCI, and/or an additionalPCI index associated with the (selected) candidate target cell may be a SSB configuration used to perform the L1 beam/cell measurement for the (selected) candidate target cell.

In some implementations, during the timing gap, the UE may assume that the TCI state or the QCL assumption for the DL channel(s)/signal(s) of the (selected) candidate target cell is identical to the TCI state or QCL assumption that is applied to the SSB associated with a cell ID, a PCI, and/or an additionalPCI index associated with the (selected) candidate target cell. The SSB associated with a cell ID, a PCI, and/or an additionalPCI index associated with the (selected) candidate target cell may be a SSB configuration used to perform the L1 beam/cell measurement for the (selected) candidate target cell.

In some implementations, during the timing gap, a UE may transmit UL channel(s)/signal(s) based on an antenna port QCL parameter associated with the SSB associated with a cell ID, a PCI, and/or an additionalPCI index associated with the (selected) candidate target cell. The SSB associated with a cell ID, a PCI, and/or an additionalPCI index associated with the (selected) candidate target cell may be a SSB configuration used to perform the L1 beam/cell measurement for the (selected) candidate target cell.

In some implementations, the cell switch MAC CE may include a TCI field indicating the TCI state corresponding to the selected candidate target cell. The type of the TCI state indicated in the cell switch MAC CE may be determined based on an RRC parameter used to configure the type of the TCI states.

In some implementations, if the RRC parameter configures/indicates a separate mode, the type of the TCI state(s) indicated in the cell switch MAC CE may include DL TCI state and/or UL TCI state. The TCI state indicated in the cell switch MAC CE may include the TCI state(s) configured in the list of UL TCI states and/or the TCI state(s) configured in the list of DL TCI states. The list of UL TCI states and the list of DL TCI states may be configured in the RRC pre-configuration (e.g., in an RRC message received during the action (a) (RRC pre-configuration)) corresponding to the selected target cell or in the RRC pre-configuration (e.g., in an RRC message received during the action (a) (RRC pre-configuration)) corresponding to the LTM procedure.

In some implementations, if the list of DL TCI states (only) includes one DL TCI state or the list of DL TCI states (only) includes one DL TCI state corresponding to the selected target cell, the TCI field included in the cell switch MAC CE may not be present or may be absent. In some implementations, if the list of UL TCI states (only) includes one UL TCI state or the list of UL TCI states (only) includes one UL TCI state corresponding to the selected target cell, the TCI field included in the cell switch MAC CE may not be present or may be absent.

In some implementations, if the list of DL TCI states (only) includes one DL TCI state and/or the list of UL TCI states (only) includes one UL TCI state, the TCI field included in the cell switch command may not be present or may be absent. In some implementations, if the list of DL TCI states (only) includes one DL TCI state corresponding to the selected target cell and/or the list of UL TCI states (only) includes one UL TCI state corresponding to the selected target cell, the TCI field included in the cell switch MAC CE may not be present or may be absent.

In some implementations, if the RRC parameter configures/indicates a joint mode, the type of the TCI state(s) indicated in the cell switch MAC CE may include a joint TCI state. In addition, the RRC parameter may be included in the RRC pre-configuration (e.g., in an RRC message received during the action (a) (RRC pre-configuration)) corresponding to the selected candidate cell. The TCI state indicated in the cell switch MAC CE may include the TCI state(s) configured in the list of joint TCI states. The list of joint TCI states may be configured in the RRC pre-configuration (e.g., in an RRC message received during the action (a) (RRC pre-configuration)) corresponding to the selected target cell or in the RRC pre-configuration (e.g., in an RRC message received during the action (a) (RRC pre-configuration)) corresponding to the LTM procedure.

In some implementations, if the list of joint TCI states (only) includes one joint TCI state or the list of joint TCI states (only) includes one joint TCI state corresponding to the selected candidate target cell, the TCI field included in the cell switch MAC CE may not be present or may be absent.

In some implementations, the TCI states (e.g., DL TCI states, UL TCI states, and joint TCI states) corresponding to the selected candidate target cell may be associated with the PCI of the selected candidate target cell and/or the additionalPCI index of the selected candidate target cell.

In some implementations, after receiving the cell switch MAC CE, a UE may apply the DL TCI state indicated in the cell switch MAC CE for receiving the SSB corresponding to the selected candidate target cell to achieve the DL synchronization to the selected candidate target cell. The SSB configuration associated with the selected candidate target cell may be included in an RRC (pre-)configuration associated with the selected candidate target cell, a cell switch MAC CE, and/or a list of SSB configurations configured by the source cell/gNB.

In some implementations, a UE may perform the DL synchronization based on the SSB configuration corresponding to the selected candidate target cell. The SSB configuration corresponding to the selected candidate target cell may be included in the RRC pre-configuration.

In some implementations, after receiving the cell switch MAC CE, a UE may apply the UL TCI state or joint TCI state to transmit preamble to the selected candidate target cell based on the physical RACH resource(s) (e.g., preamble index, RACH occasion, transmit power) configured in the RRC pre-configuration corresponding to the selected candidate target cell. The UE may apply the UL TCI state or the joint TCI state to transmit preamble, Msg 1, and/or Msg 3 to the selected candidate target cell in the RA procedure (e.g., a 2-step RA procedure, a 4-step RA procedure, a CBRA procedure, a CFRA procedure).

In some implementations, a UE may apply the beam associated with the SSB corresponding to the selected candidate target cell for receiving DL channel(s)/signal(s) from the selected candidate target cell and/or transmitting UL channel(s)/signal(s) to the selected candidate target cell. The configuration of the SSB corresponding to the selected candidate target cell may be included in the RRC pre-configuration.

In some implementations, the UE may assume that the DM-RS ports of DL channel(s)/signal(s) of the (selected) candidate target cell are QCLed with the SSB with respect to a QCL assumption (e.g., ‘typeA’, ‘typeB’, ‘typeC’, and/or ‘typeD’). The configuration of the SSB may be associated with the (selected) candidate target cell (e.g., the configuration of the SSB may be associated with a cell ID, a PCI, and/or an additionalPCI index associated with the (selected) candidate target cell). The SSB associated with a cell ID, a PCI, and/or an additionalPCI index associated with the (selected) candidate target cell may be a SSB configuration used to perform the L1 beam/cell measurement for the (selected) candidate target cell.

In some implementations, the UE may assume that the TCI state or the QCL assumption for the DL channel(s)/signal(s) of the (selected) candidate target cell is identical to the TCI state or QCL assumption that is applied to the SSB associated with a cell ID, a PCI, and/or an additionalPCI index associated with the (selected) candidate target cell. The SSB associated with a cell ID, a PCI, and/or an additionalPCI index associated with the (selected) candidate target cell may be a SSB configuration used to perform the L1 beam/cell measurement for the (selected) candidate target cell.

In some implementations, a UE may transmit UL channel(s)/signal(s) based on an antenna port QCL parameter associated with the SSB associated with a cell ID, a PCI, and/or an additionalPCI index associated with the (selected) candidate target cell. The SSB associated with a cell ID, a PCI, and/or an additionalPCI index associated with the (selected) candidate target cell may be a SSB configuration used to perform the L1 beam/cell measurement for the (selected) candidate target cell.

In some implementations, after receiving the cell switch MAC CE, a UE may apply the DL TCI state for receiving DCI for performing the RA procedure. The DCI may be received in the common search space or the LTM-dedicated search space. In some implementations, the UE may receive the DCI for performing a CFRA procedure.

In some implementations, a cell switch MAC CE may include one or more TCI fields. If a UE is indicated to perform multi-TRP operation after switching to the selected candidate target cell, the cell switch MAC CE may include multiple TCI fields (e.g., 2 TCI fields). And the TCI states indicated in the multiple TCI fields may be applied to perform multi-TRP operation. For example, a cell switch MAC CE may include two TCI fields. The first TCI field may indicate the TCI state applied for receiving the DL channel(s)/signal(s) from a first TRP associated with the selected candidate target cell and/or transmitting UL channel(s)/signal(s) to the first TRP associated with the selected candidate target cell. And the second TCI field may indicate the TCI state applied for receiving the DL channel(s)/signal(s) from a second TRP associated with the selected candidate target cell and/or transmitting UL channel(s)/signal(s) to the second TRP associated with the selected candidate target cell. The first TRP and the second TRP may be associated with a first SRS resource set and a second SRS resource set, respectively.

In some implementations, a cell switch MAC CE may include a TCI field. If a UE is indicated to perform multi-TRP operation after switching to the selected candidate target cell, the cell switch MAC CE may include multiple TCI states (e.g., 2 DL TCI states and/or 2 UL TCI states) in the TCI field. For example, a cell switch MAC CE may include one TCI field. The first TCI state included in the TCI field may be applied for receiving the DL channel(s)/signal(s) from a first TRP associated with the selected candidate target cell and/or transmitting UL channel(s)/signal(s) to the first TRP associated with the selected candidate target cell. And the second TCI state included in the TCI field may be applied for receiving the DL channel(s)/signal(s) from a second TRP associated with the selected candidate target cell and/or transmitting UL channel(s)/signal(s) to the second TRP associated with the selected candidate target cell. The first TRP and the second TRP may be associated with a first SRS resource set and a second SRS resource set, respectively.

In some implementations, the RRC pre-configuration corresponding to each candidate target cell may include the RRC parameter to indicate whether the candidate target cell enables multi-TRP operation or not.

In some implementations, a cell switch MAC CE may include one or more TCI fields. In addition, whether the TCI field included in the cell switch MAC CE is present or not may be indicated by a field included in the cell switch MAC CE. For example, a cell switch MAC CE may include a first TCI field, a second TCI field, a first field, and a second field. The first field may indicate whether the octets contain the first TCI field. If the first field is set to 1, the first TCI field may be present; otherwise, the first TCI field may not be present (or may be absent) so the MAC entity may ignore the first TCI field. Similarly, if the second field is set to 1, the second TCI field may be present; otherwise, the second TCI field may not be present (or may be absent) so the MAC entity may ignore the second TCI field. The TCI states indicated in the different TCI fields may be associated with different candidate target cells. For example, the first TCI state may be associated with the PCell of the selected candidate target cell and the second TCI state may be associated with the SCell of the selected candidate target cell. For example, the first TCI state indicated in the first TCI field may be associated with the PCell of the selected candidate target cell and other TCI states (e.g., the second TCI state, the third TCI state, the fourth TCI state) indicated in the other TCI fields (e.g., the second TCI field, the third TCI field, the fourth TCI field) may be associated with the SCells of the selected candidate target cell (or the SCells which is associated with a PCell/PSCell (e.g., the selected candidate target cell)).

In some implementations, a cell switch MAC CE may include the PCIs of the first selected candidate target cell and the second selected candidate target cell. The first TCI state (e.g., the TCI state indicated in the field with the lowest ID) indicated in the cell switch MAC CE may be associated with the PCI of the first selected candidate target cell. And the second TCI state (e.g., the TCI state indicated in the field with the higher ID) indicated in the cell switch MAC CE may be associated with the PCI of the second selected candidate target cell.

In some implementations, a cell switch MAC CE may include multiple fields to indicate the PCIs for the selected candidate target cells. For example, the cell switch MAC CE may include a first PCI field and a second PCI field to indicate the PCI values of a first selected candidate target cell and a second selected candidate target cell, respectively. The PCI value of the first selected candidate target cell may be smaller than the PCI value of the second selected candidate target cell, or the additionalPCI index of the first selected candidate target cell may be smaller than the additionalPCI index of the second selected candidate target cell.

In some implementations, a cell switch MAC CE may include multiple fields (e.g., Pᵢ field) used to indicate whether the candidate target cell is selected to switch or not. For example, if the Pᵢ field is set to 1, the candidate target cell associated with the i-th additionalPCI index (e.g., additionalPCIindex=i) may be selected to switch.

In some implementations, the cell switch MAC CE may include more than one codepoint/field including the TCI state corresponding to the selected candidate target cell. In some implementations, a UE may be indicated with one or more beams for transmitting UL signals to the selected candidate target cell and/or for receiving DL signals transmitted from the selected candidate target cell via the cell switch MAC CE transmitted by the source cell/gNB.

In some implementations, if a candidate cell is not configured with any RSs applied for the L1 measurement in the RRC pre-configuration dedicated to the candidate target cell by the source cell/gNB, the TCI state ID field(s) included in the cell switch MAC CE may not be present (or may be absent). The configuration of the SSB of the candidate cell may be configured in a list of SSB configurations corresponding to different candidate target cells by the source cell/gNB to the UE. For example, if the RRC pre-configuration of the candidate target cell #M received by a UE is not configured with any RS(s) used for the L1 measurement by the source cell/gNB and the candidate target cell # is the selected candidate target cell, the TCI state ID field(s) included in the cell switch MAC CE received by the UE may not be present (or may be absent).

In some implementations, the beam indication in the cell switch MAC-CE may correspond to a specific channel. For example, the cell switch MAC-CE may include a beam indication for DL receptions based on the information received from the RRC pre-configuration (e.g., PDSCH-Config, CSI-RS Config). For example, the cell switch MAC-CE may include a beam indication for UL transmissions based on the information received from the RRC pre-configuration (e.g., PUSCH-Config, SRS-Config).

In some implementations, a cell switch MAC CE may include at least one of the following fields (a)-(l):
(a) Physical Cell ID: This field may indicate the identity of the candidate target cell for which the MAC CE applies.
(b) CC group: This field may indicate a set of candidate target cells.
(c) BWP ID: This field may indicate the BWP of the candidate target cell that the MAC CE applies to.
(d) D/U: This field may indicate the TCI state ID is applied to the DL or UL.
(e) TCI state ID: This field may indicate an identifier of the TCI state used for the selected candidate target cell. It may be noted that this field may indicate one of the following (i)-(viii):
(i) A DL TCI state,
(ii) A UL TCI state,
(iii) A DL TCI state and an UL TCI state,
(iv) A joint TCI state,
(v) Two DL TCI states,
(vi) Two UL TCI states,
(vii) Two DL TCI states and Two UL TCI states, and
(viii) Two joint TCI states.
(f) TAG ID: This field may indicate the TAG identity of the addressed TAG.
(g) Timing Advanced Command: This field may indicate the index value TA used to control the amount of timing adjustment that the MAC entity may apply.
(h) D/U: This field may indicate whether the TCI state ID in the same octet is for joint/downlink or uplink TCI state. If this field is set to 1, the TCI state ID in the same octet may be for joint/downlink. If this field is set to 0, the TCI state ID in the same octet may be for uplink.
(i) Tᵢ: This field may indicate whether each TCI codepoint has multiple TCI states or single TCI state. If Tᵢ field is set to 1, it may indicate that the i-th TCI codepoint includes the DL TCI state and the UL TCI state. If Tᵢ field is set to 0, it may indicate that the i-th TCI codepoint includes the DL TCI state/joint TCI state or the UL TCI state. The codepoint to which a TCI state is mapped is determined by its ordinal position among all the TCI state ID fields.
(j) CORESETPoolindex: This field may indicate whether the indicated DL reception or UL transmission is associated with same TRP.
(k) Applied mTRP scheme: A codepoint may indicate ‘SDM’, ‘SFN’, and ‘CJT’ scheme, respectively.
(l) R: It may be reserved bit, set to 0.

In some implementations, a cell switch MAC CE may be used to activate one or more TCI states configured in a list of TCI states, and the list of TCI states may be configured in the RRC pre-configuration corresponding to the selected candidate target cell or in the RRC pre-configuration corresponding to the LTM procedure. For example, the cell switch MAC CE may include multiple TCI state ID fields. The TCI states indicated in the multiple TCI state ID fields may correspond to the selected candidate target cell.

In some implementations, DCI (e.g., DL DCI or UL DCI) may include a TCI field indicating the TCI state corresponding to the selected candidate target cell. The type of the TCI state indicated in the DCI may be determined based on an RRC parameter used to configure the type of the TCI states. The DCI may be transmitted by the selected candidate target cell. The UE may receive the DCI based on the beam associated with the SSB of the selected candidate target cell. The configuration of the SSB of the selected candidate target cell may be included in the RRC pre-configuration.

In some implementations, the UE may assume that the DM-RS ports of the PDCCH of the (selected) candidate target cell are QCLed with the SSB with respect to a QCL assumption (e.g., ‘typeA’, ‘typeB’, ‘typeC’, and/or ‘typeD’). The configuration of the SSB may be associated with the (selected) candidate target cell (e.g., the configuration of the SSB may be associated with a cell ID, a PCI, and/or an additionalPCI index associated with the (selected) candidate target cell). The SSB associated with a cell ID, a PCI and/or an additionalPCI index associated with the (selected) candidate target cell may be a SSB configuration used to perform the L1 beam/cell measurement for the (selected) candidate target cell.

In some implementations, the UE may assume that the TCI state or the QCL assumption for the PDCCH of the (selected) candidate target cell is identical to the TCI state or QCL assumption that is applied to the SSB associated with a cell ID, a PCI, and/or an additionalPCI index associated with the (selected) candidate target cell. The SSB associated with a cell ID, a PCI, and/or an additionalPCI index associated with the (selected) candidate target cell may be a SSB configuration used to perform the L1 beam/cell measurement for the (selected) candidate target cell.

In some implementations, a UE may be indicated with one or more beams for receiving DL signals transmitted from the selected candidate target cell via the DCI transmitted by the selected candidate target cell. In some implementations, a UE may be indicated with one or more beams for transmitting UL signals to the selected candidate target cell via the DCI transmitted by the selected candidate target cell. In some implementations, a UE may be indicated with one or more beams for transmitting UL signals to the selected candidate target cell and/or for receiving DL signals transmitted from the selected candidate target cell via the DCI transmitted by the selected candidate target cell.

In some implementations, a UE may be configured with a list of up to X TCI state configurations within the RRC pre-configuration corresponding to each candidate target cell to decode PDSCH based on a detected PDCCH with DCI intended for the UE and the selected candidate target cell. The PDCCH with the DCI may be received based on the beam associated with the SSB of the selected candidate target cell. And the X may depend on the UE capability (e.g., the max number of configured TCI states per candidate target cell).

In some implementations, the UE may assume that the DM-RS ports of the PDCCH of the (selected) candidate target cell are QCLed with the SSB with respect to a QCL assumption (e.g., ‘typeA’, ‘typeB’, ‘typeC’, and/or ‘typeD’). The configuration of the SSB may be associated with the (selected) candidate target cell (e.g., the configuration of the SSB may be associated with a cell ID, a PCI and/or, and additionalPCI index associated with the (selected) candidate target cell). The SSB associated with a cell ID, a PCI, and/or an additionalPCI index associated with the (selected) candidate target cell may be a SSB configuration used to perform the L1 beam/cell measurement for the (selected) candidate target cell.

In some implementations, the UE may assume that the TCI state or the QCL assumption for the PDCCH of the (selected) candidate target cell is identical to the TCI state or QCL assumption that is applied to the SSB associated with a cell ID, a PCI, and/or an additionalPCI index associated with the (selected) candidate target cell. The SSB associated with a cell ID, a PCI, and/or an additionalPCI index associated with the (selected) candidate target cell may be a SSB configuration used to perform the L1 beam/cell measurement for the (selected) candidate target cell.

In some implementations, a cell switch MAC CE may be used to map multiple TCI states and/or pairs of TCI states, with one TCI state for DL channels/signals and/or one TCI state for UL channels/signals, to the codepoints of the TCI field included in the DCI for the selected candidate target cell. The PCI of the selected candidate target cell may be indicated in the cell switch MAC CE.

In some implementations, a UE may be indicated with one or more beams corresponding to each candidate target cell via a beam indicating MAC CE transmitted by the source cell/gNB. The beam indicating MAC CE may include one or more fields indicating one or more TCI states associated with a candidate target cell. In addition, each of the one or more fields indicating one or more TCI states may be associated with one additionalPCI index or one PCI index.

In some implementations, a beam indicating MAC CE used to indicate one or more beams corresponding to different candidate target cells may be received by the UE before the UE receives the cell switch MAC CE. The beam indicating MAC CE may include at least one of the following fields (a)-(d):
(a) Cᵢ: This field may indicate whether the TCI state ID field of the candidate target cell associated with the i-th additionalPCI index (e.g., additionalPCIindex=i) or the i-th PCI index is present or not. If Cᵢ is set to 1, the TCI state ID field of the candidate target cell associated with the i-th additionalPCI index (e.g., additionalPCIindex=i) may be present; otherwise, the TCI state ID field of the candidate target cell associated with the i-th additionalPCI index (e.g., additionalPCIindex=i) may not be present (may be absent).
(b) D/U: This field may indicate the TCI state ID is applied to the DL or UL.
(c) TCI state ID: This field may indicate an identifier of the TCI state used for the selected candidate target cell. It may be noted that this field may indicate one of the following (i)-(viii):
(i) A DL TCI state,
(ii) A UL TCI state,
(iii) A DL TCI state and an UL TCI state,
(iv) A joint TCI state,
(v) Two DL TCI states,
(vi) Two UL TCI states,
(vii) Two DL TCI states and Two UL TCI states, and
(viii) Two joint TCI states.
(d) R: It may be reserved bit, set to 0.

In some implementations, a UE may perform the DL synchronization and/or the UL synchronization based on one or more TCI states indicated in the beam indicating MAC CE. For example, a UE may be configured with 7 candidate target cells for performing the LTM. The beam indicating MAC CE received by the UE may indicate that the TCI states of the candidate target cell is associated with cell index=X, Y, and Z, respectively. Then the UE may perform the DL synchronization and/or the UL synchronization to the candidate target cell associated with cell index=X, Y, and Z based on the TCI states indicated in the beam indicating MAC CE. For example, the beam indicating MAC CE may include three TCI state ID fields. The first TCI state ID field, second TCI state ID field, and third TCI state ID filed may indicate the DL TCI state, UL TCI state, and/or joint TCI state to the UE. The first TCI state ID field, the second TCI state ID field, and the third TCI state ID field may be associated with the candidate target cell associated with the cell index=X, Y, and Z, respectively.

The UL TCI state and/or joint TCI state indicated in the first TCI state ID field may be applied for the UL synchronization corresponding the candidate target cell associated with cell index=X. The DL TCI state and/or joint TCI state indicated in the first TCI state ID field may be applied for the DL synchronization corresponding the candidate target cell associated with cell index=X.

The UL TCI state and/or joint TCI state indicated in the second TCI state ID field may be applied for the UL synchronization corresponding the candidate target cell associated with cell index=Y. The DL TCI state and/or joint TCI state indicated in the second TCI state ID field may be applied for the DL synchronization corresponding the candidate target cell associated with cell index=Y.

The UL TCI state and/or joint TCI state indicated in the third TCI state ID field may be applied for the UL synchronization corresponding the candidate target cell associated with cell index=Z. The DL TCI state and/or joint TCI state indicated in the third TCI state ID field may be applied for the DL synchronization corresponding the candidate target cell associated with cell index=Z.

In some implementations, one or more candidate target cells may not support the unified TCI framework (e.g., one or more candidate target cells cannot be configured with UL TCI states and/or joint TCI states). The source cell/gNB may configure the UE with one RRC parameter for each candidate target cell to inform the UE whether or not the candidate target cell supports the unified TCI framework.

In some implementations, a UE may receive a cell group indication indicating one or more candidate target cells that support the unified TCI framework and another cell group indication indicating one or more candidate target cells that do not support the unified TCI framework.

In some implementations, a UE may be configured with one or more RRC (pre-)configurations associated with different candidate target cells. If the RRC (pre-)configuration is associated with the candidate target cell that does not support the unified TCI framework, the RRC (pre-)configuration may (only) include a list of DL TCI states.

In some implementations, a UE may be configured with a list of DL TCI states by the source cell/gNB. The list of DL TCI states may be applied for all candidate target cells that do not support the unified TCI framework. Each TCI state included in the list of TCI states may be associated with one PCI value or one SSB index. A SSB index may be associated with the SSB configuration corresponding to the candidate target cell/gNB that does not support the unified TCI framework.

In some implementations, the cell switch command may be transmitted by the source cell/gNB via a MAC CE. The cell switch MAC CE corresponding to the candidate target cell that does not support the unified TCI framework may include at least one of the following fields (a)-(e) if the selected candidate target cell does not support the unified TCI framework:
(a) Physical Cell ID: This field may indicate the identity of the candidate target cell for which the MAC CE applies.
(b) TCI state ID: This field may indicate an identifier of the DL TCI state used for the selected candidate target cell.
(c) TAG ID: This field may indicate the TAG identity of the addressed TAG.
(d) Timing Advanced Command: This field may indicate the index value TA used to control the amount of timing adjustment that the MAC entity may apply.
(e) R: It may be reserved bit, set to 0.

The TCI states indicated in the cell switch MAC CE corresponding to the candidate target cell that does not support the unified TCI framework may include (only) DL TCI states. For example, the UE may not expect to receive UL TCI states and/or joint TCI states in the cell switch MAC CE when the cell switch MAC CE is associated with the candidate target cell that does not support the unified TCI framework. For example, the UE may ignore the D/U field(s) included in the cell switch MAC CE, if the D/U field(s) exists, when the cell switch MAC CE is associated with the candidate target cell that does not support the unified TCI framework. For example, the UE may regard the D/U field(s) as ‘D’ if the D/U field(s) is included in the cell switch command, when the cell switch MAC CE is associated with the candidate target cell that does not support the unified TCI framework. Instead, the TCI states indicated in the cell switch MAC CE corresponding to the candidate target cell that supports the unified TCI framework may include DL TCI states, UL TCI states, and/or joint TCI states. And the type of the TCI states included in the TCI state ID field may be indicated by the D/U field(s) included in the cell switch MAC CE.

In some implementations, if the list of TCI states only includes one DL TCI state corresponding to the selected target cell that does not support the unified TCI framework, the TCI field included in the cell switch MAC CE may not be present or may be absent.

In some implementations, if a UE is indicated to switch to the candidate target cell that does not support the unified TCI framework and/or FR2 (e.g., the selected candidate target cell does not support the unified TCI framework and/or FR2) by the source cell/gNB via a cell switch MAC CE, the UE may expect that the TCI state ID field may not be present (or may be absent) in the cell switch MAC CE.

In some implementations, if a UE is indicated to switch to the candidate target cell that does not support the unified TCI framework and/or FR2 (e.g., the selected candidate target cell does not support the unified TCI framework and/or FR2) by the source cell/gNB via a cell switch MAC CE, the TCI state ID field included in the cell switch MAC CE may not be present (or may be absent). In addition, the UE may apply the beam associated with an SSB corresponding to the selected candidate target cell for receiving the DL channel(s)/signal(s) transmitted from the selected candidate target cell and/or for transmitting the UL channel(s)/signal(s) to the selected candidate target cell, and the UE may assume that the DM-RS ports of DL channel(s)/signal(s) of the (selected) candidate target cell are QCLed with the SSB with respect to a QCL assumption (e.g., ‘typeA’, ‘typeB’, ‘typeC’, and/or ‘typeD’).

The configuration of the SSB may be associated with the (selected) candidate target cell (e.g., the configuration of the SSB may be associated with a cell ID, a PCI, and/or an additionalPCI index associated with the (selected) candidate target cell). The SSB associated with a cell ID, a PCI, and/or an additionalPCI index associated with the (selected) candidate target cell may be a SSB configuration used to perform the L1 beam/cell measurement for the (selected) candidate target cell, and the UE may assume that the TCI state or the QCL assumption for the DL channel(s)/signal(s) of the (selected) candidate target cell is identical to the TCI state or QCL assumption that is applied to the SSB associated with a cell ID, a PCI, and/or an additionalPCI index associated with the (selected) candidate target cell.

The SSB associated with a cell ID, a PCI, and/or an additionalPCI index associated with the (selected) candidate target cell may be a SSB configuration used to perform the L1 beam/cell measurement for the (selected) candidate target cell or the UE may transmit UL channel(s)/signal(s) based on an antenna port QCL parameter associated with the SSB associated with a cell ID, a PCI, and/or an additionalPCI index associated with the (selected) candidate target cell. The SSB associated with a cell ID, a PCI, and/or an additionalPCI index associated with the (selected) candidate target cell may be a SSB configuration used to perform the L1 beam/cell measurement for the (selected) candidate target cell. The SSB corresponding to the selected candidate target cell may be configured in the action (a) (RRC pre-configuration) during the LTM procedure.

In some implementations, a UE may not expect to receive the beam indication referring to the unified TCI framework and non-unified TCI framework simultaneously. In some implementations, a UE may be configured with a common RRC (pre-) configuration associated with all candidate target cells and a plurality of RRC (pre-) configurations associated with different candidate target cells from the source cell/gNB. In addition, the UE may be configured with an RRC parameter to indicate the type of the TCI state, and the RRC parameter may be included in the common RRC (pre-)configuration. The UE may receive a cell switch MAC CE including TCI state ID field.

In a case that the TCI state ID field is present in the cell switch command and the type of the TCI states indicated by the RRC parameter is a separate mode, the TCI state indicated in the TCI state ID field may include DL TCI state and/or UL TCI state. The UE may apply the DL TCI state for receiving the DL channel(s)/signal(s) from the selected candidate cell and/or apply the UL TCI state for transmitting the UL channel(s)/signal(s) to the selected candidate cell.

In a case that TCI state ID field is present in the cell switch MAC CE and the type of the TCI states indicated by the RRC parameter is a joint mode, the TCI state indicated in the TCI state ID field may include a joint TCI state. The UE may apply the joint TCI state for receiving the DL channel(s)/signal(s) from the selected candidate cell and/or transmitting the UL channel(s)/signal(s) to the selected candidate cell.

In a case that the TCI state ID field is not present (or is absent) in the cell switch MAC CE, the UE may apply the beam associated with the SSB associated with the selected candidate target cell for receiving the DL channel(s)/signal(s) from the selected candidate cell and/or transmitting the UL channel(s)/signal(s) to the selected candidate cell. In some implementations, the cell switch command and the cell switch MAC CE may be used interchangeably in the present disclosure.

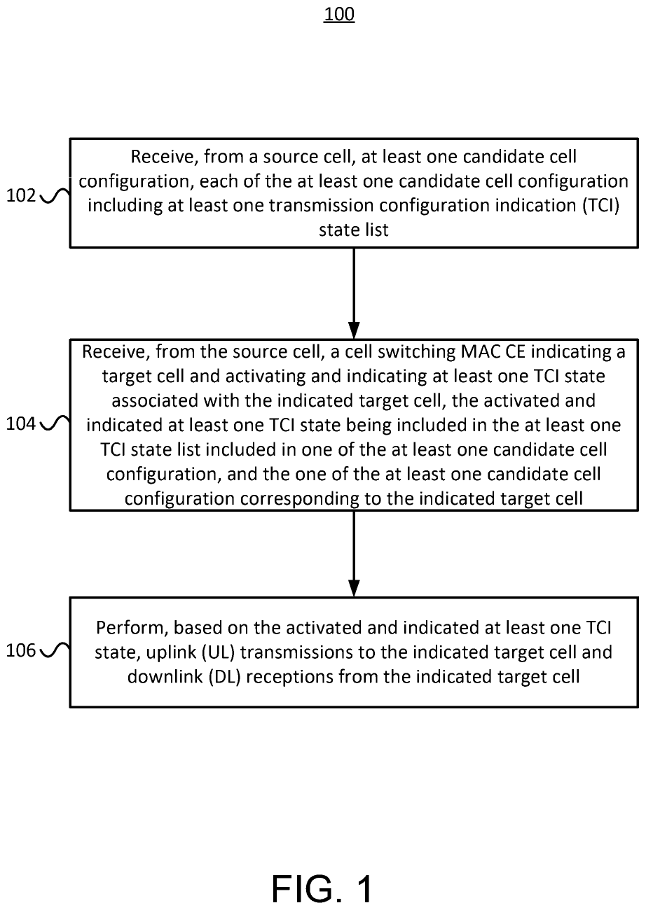

FIG. 1 is a flowchart 100 illustrating a method for beam indication for LTM performed by a UE, according to an example implementation of the present disclosure.

In action 102, the UE may receive, from a source cell, at least one candidate cell configuration. Each of the at least one candidate cell configuration may include at least one transmission configuration indication (TCI) state list.

In action 104, the UE may receive, from the source cell, a cell switching MAC CE indicating a target cell and activating and indicating at least one TCI state associated with the indicated target cell. The activated and indicated at least one TCI state may be included in the at least one TCI state list included in one of the at least one candidate cell configuration, and the one of the at least one candidate cell configuration may correspond to the indicated target cell.

In some implementations, the activated and indicated at least one TCI state may be associated with a synchronization signal block (SSB) associated with the indicated target cell, and the SSB may be configured to perform layer 1 (L1) beam measurement for the indicated target cell.

In action 106, the UE may perform, based on the activated and indicated at least one TCI state, uplink (UL) transmissions to the indicated target cell and downlink (DL) receptions from the indicated target cell.

In some implementations, the activated and indicated at least one TCI state may be applied to the UL transmissions to the indicated target cell and the DL receptions from the indicated target cell after a timing gap. In some implementations, the timing gap may be predefined or configured by the source cell.

In some implementations, the UE may further receive, from the source cell, a radio resource control (RRC) parameter indicating a joint mode or a separate mode. In a case that the RRC parameter indicates the joint mode, the activated and indicated at least one TCI state may be a joint TCI state included in a joint TCI state list of the at least one TCI state list, and the UL transmissions to the indicated target cell and the DL receptions from the indicated target cell may be performed based on the joint TCI state, and in a case that the RRC parameter indicates the separate mode, the activated and indicated at least one TCI state may be a DL TCI state included in a DL TCI state list of the at least one TCI state list and an UL TCI state included in an UL TCI state list of the at least one TCI state list, the UL transmissions to the indicated target cell may be performed based on the UL TCI state, and the DL receptions from the indicated target cell may be performed based on the DL TCI state.

In some implementations, the source cell and the indicated target cell may be associated with a same BS. In some implementations, the source cell and the indicated target cell may be associated with different BSs (e.g., a first BS and a second BS). For example, the source cell may be associated with the first BS, and the indicated target cell may be associated with the second BS.

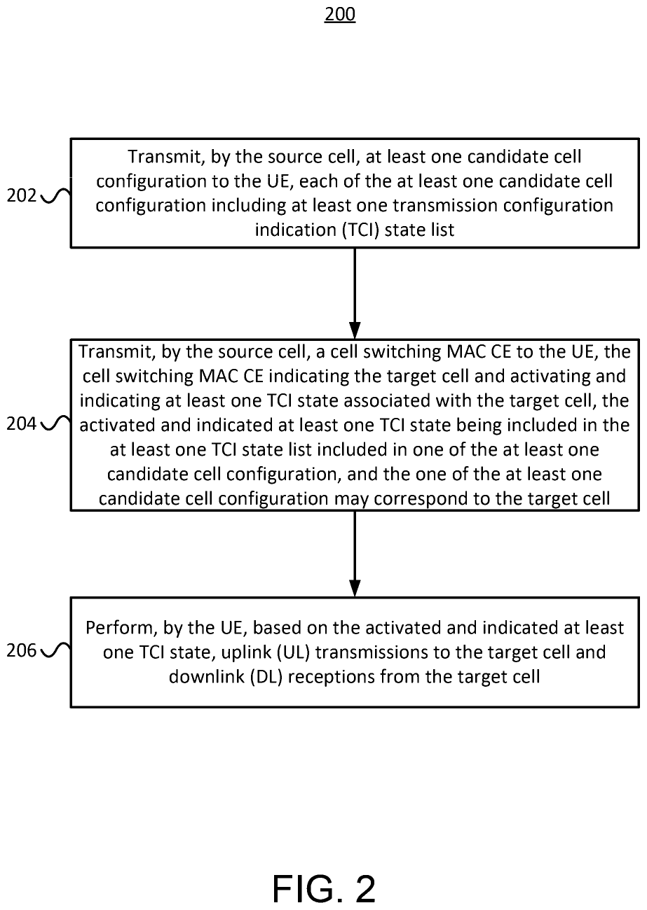

FIG. 2 is a flowchart 200 illustrating a method for beam indication for LTM performed by a communication system, according to an example implementation of the present disclosure.

The communication system may include a UE, a source cell, and a target cell.

In action 202, the source cell may transmit, to the UE, at least one candidate cell configuration. Each of the at least one candidate cell configuration may include at least one transmission configuration indication (TCI) state list.

In action 204, the source cell may transmit, to the UE, a cell switching MAC CE indicating the target cell and activating and indicating at least one TCI state associated with the target cell. The activated and indicated at least one TCI state may be included in the at least one TCI state list included in one of the at least one candidate cell configuration, and the one of the at least one candidate cell configuration may correspond to the target cell.

In some implementations, the activated and indicated at least one TCI state may be associated with a synchronization signal block (SSB) associated with the target cell, and the SSB may be configured to perform layer 1 (L1) beam measurement for the target cell.

In action 206, the UE may perform, based on the activated and indicated at least one TCI state, uplink (UL) transmissions to the target cell and downlink (DL) receptions from the target cell.

In some implementations, the activated and indicated at least one TCI state may be applied to the UL transmissions to the target cell and the DL receptions from the target cell after a timing gap. In some implementations, the timing gap may be predefined or configured by the source cell.

In some implementations, the source cell may further transmit, to the UE, a radio resource control (RRC) parameter indicating a joint mode or a separate mode. In a case that the RRC parameter indicates the joint mode, the activated and indicated at least one TCI state may be a joint TCI state included in a joint TCI state list of the at least one TCI state list, and the UE may perform, based on the joint TCI state, the UL transmissions to the target cell and the DL receptions from the target cell, and in a case that the RRC parameter indicates the separate mode, the activated and indicated at least one TCI state may be a DL TCI state included in a DL TCI state list of the at least one TCI state list and an UL TCI state included in an UL TCI state list of the at least one TCI state list, the UE may perform, based on the UL TCI state, the UL transmissions to the target cell, and the UE performs, based on the DL TCI state, the DL receptions from the target cell.

In some implementations, the source cell and the target cell may be associated with a same BS. In some implementations, the source cell and the target cell may be associated with different BSs (e.g., a first BS and a second BS). For example, the source cell may be associated with the first BS, and the target cell may be associated with the second BS.

The technical problem addressed by the present disclosure is how to manage the beam indications efficiently and accurately in LTM scenarios. Specifically, in LTM scenarios, it is crucial to manage beam indications accurately to ensure seamless communication during cell switching. The problem lies in how to effectively receive and utilize configuration information from a source cell to manage beam indications when transitioning to a target cell. Another aspect of the problem how to enable the UE to dynamically switch between cells (from a source cell to a target cell) while maintaining the integrity and efficiency of uplink and downlink communications.

In the present disclosure, by receiving candidate cell configurations and specific TCI states associated with target cells, the UE can optimize its beamforming strategies, leading to more efficient uplink and downlink communications. The method provided in the present disclosure enables quicker and more efficient cell switching by using predefined TCI states. The method provided in the present disclosure potentially reduces the latency associated with cell switching and maintains communication quality during the mobility process. Furthermore, by utilizing the TCI states that are part of the candidate cell configuration, the UE can adapt more effectively to network conditions and requirements, ensuring better compatibility and responsiveness.

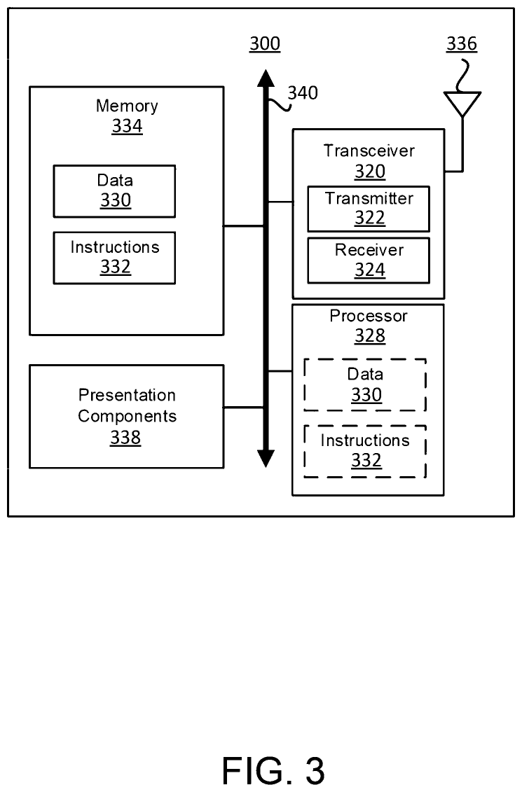

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIGS. 1 and 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIGS. 1 and 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A user equipment (UE) for beam indication for layer 1/layer 2-triggered mobility (LTM), the UE comprising:
at least one processor; and
at least one non-transitory computer-readable medium coupled to the at least one processor and storing one or more computer-executable instructions that, when executed by the at least one processor, cause the UE to:
receive, from a source cell, at least one candidate cell configuration, each of the at least one candidate cell configuration comprising at least one transmission configuration indication (TCI) state list;
receive, from the source cell, a cell switching medium access control (MAC) control element (CE) indicating a target cell, and indicating and activating at least one TCI state associated with the indicated target cell, the at least one TCI state being included in the at least one TCI state list included in one of the at least one candidate cell configuration, the one of the at least one candidate cell configuration corresponding to the indicated target cell; and
perform, based on the at least one TCI state, uplink (UL) transmissions to the indicated target cell and downlink (DL) receptions from the indicated target cell.

2. The UE of claim 1, wherein the one or more computer-executable instructions, when executed by the at least one processor, further cause the UE to:
receive, from the source cell, a radio resource control (RRC) parameter indicating a joint mode or a separate mode, wherein:
in a case that the RRC parameter indicates the joint mode:
the at least one TCI state comprises a joint TCI state included in a joint TCI state list of the at least one TCI state list, and
the UL transmissions to the indicated target cell and the DL receptions from the indicated target cell are performed based on the joint TCI state, and
in a case that the RRC parameter indicates the separate mode;
the at least one TCI state comprises a DL TCI state included in a DL TCI state list of the at least one TCI state list, and a UL TCI state included in a UL TCI state list of the at least one TCI state list,
the UL transmissions to the indicated target cell are performed based on the UL TCI state, and
the DL receptions from the indicated target cell are performed based on the DL TCI state.

3. The UE of claim 1, wherein:
the at least one TCI state is associated with a synchronization signal block (SSB) associated with the indicated target cell, and
the SSB is configured to perform a layer 1 (L1) beam measurement for the indicated target cell.

4. The UE of claim 1, wherein the at least one TCI state is applied to the UL transmission and the DL receptions after a timing gap.

5. The UE of claim 4, wherein the timing gap is predefined or configured by the source cell.

6. A method performed by a user equipment (UE) for beam indication for layer 1/layer 2 triggered mobility (LTM), the method comprising:
receiving, from a source cell, at least one candidate cell configuration, each of the at least one candidate cell configuration comprising at least one transmission configuration indication (TCI) state list;
receiving, from the source cell, a cell switching medium access control (MAC) control element (CE) indicating a target cell, and indicating and activating at least one TCI state associated with the indicated target cell, the at least one TCI state being included in the at least one TCI state list included in one of the at least one candidate cell configuration, the one of the at least one candidate cell configuration corresponding to the indicated target cell; and
performing, based on the at least one TCI state, uplink (UL) transmissions to the indicated target cell and downlink (DL) receptions from the indicated target cell.

7-10. (canceled)

11. A base station (BS) for beam indication for layer 1/layer 2 triggered mobility (LTM), the BS comprising:
at least one processor; and
at least one non-transitory computer-readable medium coupled to the at least one processor and storing one or more computer-executable instructions that, when executed by the at least one processor, cause the BS to:
transmit, toa user equipment (UE) via a source cell, at least one candidate cell configuration, each of the at least one candidate cell configuration comprising at least one transmission configuration indication (TCI) state list;
transmit, to the UE via the source cell, a cell switching medium access control (MAC) control element (CE) indicating a target cell, and indicating and activating at least one TCI state associated with the indicated target cell, the at least one TCI state being included in the at least one TCI state list included in one of the at least one candidate cell configuration, the one of the at least one candidate cell configuration corresponding to the indicated target cell;
receive, based on the at least one TCI state, uplink (UL) transmissions performed by the UE via the indicated target cell; and
perform, based on the at least one TCI state, downlink (DL) transmissions to the UE via the indicated target cell.

12. The BS of claim 11, wherein the one or more computer-executable instructions, when executed by the at least one processor, further cause the BS to:
transmit, to the UE via the source cell, a radio resource control (RRC) parameter indicating a joint mode or a separate mode, wherein:
in a case that the RRC parameter indicates the joint mode:
the at least one TCI state comprises a joint TCI state included in a joint TCI state list of the at least one TCI state list,
the UL transmissions performed by the UE via the indicated target cell are received based on the joint TCI state, and
the DL transmissions to the UE via the indicated target cell are performed based on the joint TCI state, and
in a case that the RRC parameter indicates the separate mode:
the at least one TCI state comprises a DL TCI state included in a DL TCI state list of the at least one TCI state list, and a UL TCI state included in a UL TCI state list of the at least one TCI state list,
the UL transmissions performed by the UE via the indicated target cell are received based on the UL TCI state, and
the DL transmissions to the UE via the indicated target cell are performed based on the DL TCI state.

13. The BS of claim 11, wherein:
the at least one TCI state is associated with a synchronization signal block (SSB) associated with the indicated target cell, and
the SSB is configured to perform a layer 1 (L1) beam measurement for the indicated target cell.

14. The BS of claim 11, wherein the at least one TCI state is applied to the receptions of the UL transmissions performed by the UE and the DL transmission after a timing gap.

15. The BS of claim 14, wherein the timing gap is predefined or configured by the source cell.
